(19) United States
(12) Patent Application Publication
(10) Pub. No.: US 2014/0344495 A1
(43) Pub. Date: Nov. 20, 2014

(54) DOCKING STATION WITH HOOKING FUNCTION

(71) Applicants: Ping-Shun Zeung, Taipei City (TW); Johnny Chen, Taipei City (TW)

(72) Inventors: Ping-Shun Zeung, Taipei City (TW); Johnny Chen, Taipei City (TW)

(73) Assignee: I/O INTERCONNECT INC., Taipei City (TW)

(21) Appl. No.: 13/943,815

(22) Filed: Jul. 17, 2013

Related U.S. Application Data
(63) Continuation-in-part of application No. 13/937,161, filed on Jul. 8, 2013.
Application No. 13/937,161 is a continuation-in-part of application No. 13/896,282, filed on May 16, 2013.

(51) Int. Cl. G06F 1/16

(52) U.S. Cl. CPC G06F 1/1632
USPC 710/303

(57) ABSTRACT

A dock for connecting a smartphone to a display and a laptop is disclosed. The dock transfers audio/video data from a smartphone to a display, establishes a wireless link with the smartphone and intercepts input device event messages of a laptop so that a user can use input devices of the laptop to control the smartphone. The dock has a controller with a switch, a wireless communication module, a hook procedure processor, two USB connectors, an AV converter, an AV switch, and two AV connectors.

### CROSS-REFERENCE TO RELATED APPLICATIONS

This application is a continuation-in-part of U.S. patent application Ser. No. 13/937,161 filed Jul. 8, 2013, now pending, which is a continuation-in-part of U.S. patent application Ser. No. 13/896,282, filed May 16, 2013, now pending.

### BACKGROUND OF THE INVENTION

1. Technical Field

The invention relates to docking stations, particularly to a docking station which can intercept input device event messages of a laptop computer to control a smartphone.

2. Related Art

A smartphone is a mobile phone built on a mobile operating system, with more advanced computing capability connectivity than a conventional cellular phone. In essence, a smartphone is a computer-based cellular phone. As a result, more and more users treat a smartphone as a mixture of a cellular phone and a laptop or tablet computer.

There must be a rechargeable battery, a touchscreen panel and a connection port in a smartphone. When a smartphone is used as a laptop computer at home or office, a docking station is needed for charging battery, data communication and connecting human interface devices (HIDs) such as a keyboard and mouse. Also, an external display much larger than the touchscreen panel of a smartphone is required by most users.

Generally, a smartphone is provided with only one communication port, for example, a micro-USB port. For both input/output bidirectional data communication and audio/video unidirectional data transmission, some smartphones are provided with a micro-USB port with a built-in mobile audio/video interface such as the Mobile High-Definition Link (MHL) or the Mobility DisplayPort (MyDP) interface.

However, such an MHL-enabled or MyDP-enabled micro-USB port has to cease its USB functions while the MHL or MyDP function is being activated, and vice versa. In more detail, a user cannot use the MHL-enabled or MyDP-enabled micro-USB port to connect a keyboard, mouse or any other USB-HIDs when the port is connected to an external display. The only solution to simultaneously connect an external display and HIDs is to wirelessly connect HIDs via BLUETOOTH and to wiredly connect an external display via the MHL-enabled or MyDP-enabled micro-USB port. This is inconvenient and complicated for users. Furthermore, BLUETOOTH HIDs are much more expensive than general USB-HIDs.

There is some smartphone manufacture to provide a smartphone product with a proprietary hybrid interface connector that combines two sub-connectors—one for audio/video data transmission and the other one for USB data communication. However, such a proprietary connector lacks compatibility with other smartphone or peripheral manufactures. Users' selectivity is seriously limited.

Some users prefer using an external keyboard, display and mouse to control a smartphone connected to a docking station. Some users may connect a laptop computer with the docking station and want to use a touchpad and keyboard of the laptop computer to control the smartphone. Under the circumstances, a docking station with a hooking function which can intercept input device event messages of a laptop computer is required.

### SUMMARY OF THE INVENTION

An object of the invention is to provide a dock station with a hooking function, which can operatively link an external display with a smartphone and a laptop computer and allows a user to control the smartphone from the external display and input devices of the laptop computer.

To accomplish the above object, the docking station of the invention includes a controller with a linking switch, a wireless communication module, a universal serial bus (USB) switch, a first USB connector, a second USB connector, a hook procedure processor, an audio/video (AV) converter, an AV switch, a first AV connector, and a second AV connector.

The wireless communication module is coupled to the controller and is capable of establishing a wireless link with an external portable electronic device. The first USB connector is used for connecting the external portable electronic device. The hook procedure processor is coupled to the controller and intercepts input device event messages of an external laptop computer to send to the controller. The second USB connector is coupled to the hook procedure processor for connecting the external laptop computer. The AV converter is coupled between the first USB connector and the controller for converting first AV data into second AV data. The AV switch has two AV inputs and an AV output for switching one of the two AV inputs to the AV output, and one of the two AV inputs is coupled to the AV converter. The first AV connector is coupled to another one of the two AV inputs of the AV switch for inputting a third AV data from the external laptop computer. The second AV connector is coupled to the AV output of the AV switch for outputting either of the second AV data and the third AV data. The controller sends the input device event messages intercepted by the hook procedure processor to the external portable electronic device through the wireless link so that input devices of the external laptop computer can be used to input data into the external portable electronic device. The AV switch is controlled by the linking switch.

### BRIEF DESCRIPTION OF THE DRAWINGS

FIG. 1 is a schematic view of the invention in use;

FIG. 2 is a block diagram of the invention;

FIG. 3 is a schematic view showing the wiring of the AV switch; and

FIG. 4 is a schematic view showing the data flow of the invention.

### DETAILED DESCRIPTION OF THE INVENTION

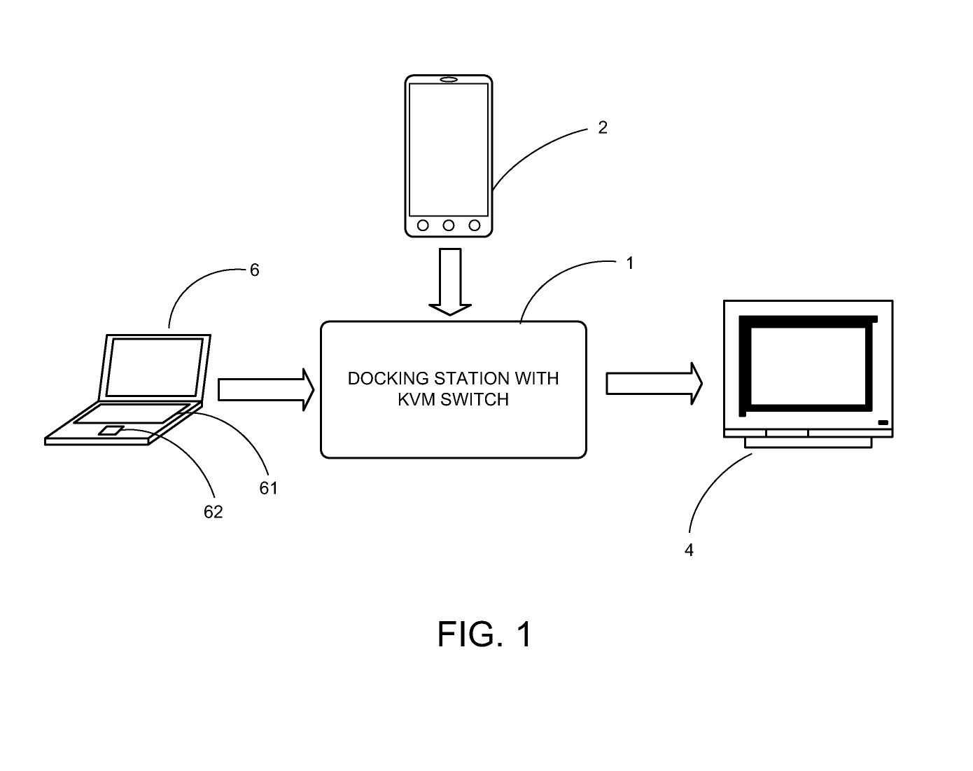

Please refer to FIG. 1, which depicts topology of the docking station of the invention in use. As shown, the docking station 1 is connected with a portable electronic device such as a smartphone 2, a display 4 and a laptop computer 6 with input devices, namely, a keyboard 61 and a touchpad 62. The docking station 1 can output audio/video (AV) data to the display 4 from either of the smartphone 2 and the laptop computer 6 and allow the smartphone 2 to be controlled by the keyboard 61 and touchpad 62. Of course, the smartphone 2 must be provided with a micro-USB connector with a mobile AV interface such as the Mobile High-Definition Link (MHL) standard or the Mobility DisplayPort (MyDP) standard. Also, the docking station 1 can electrically disconnect the laptop computer 6 to allow it work alone.

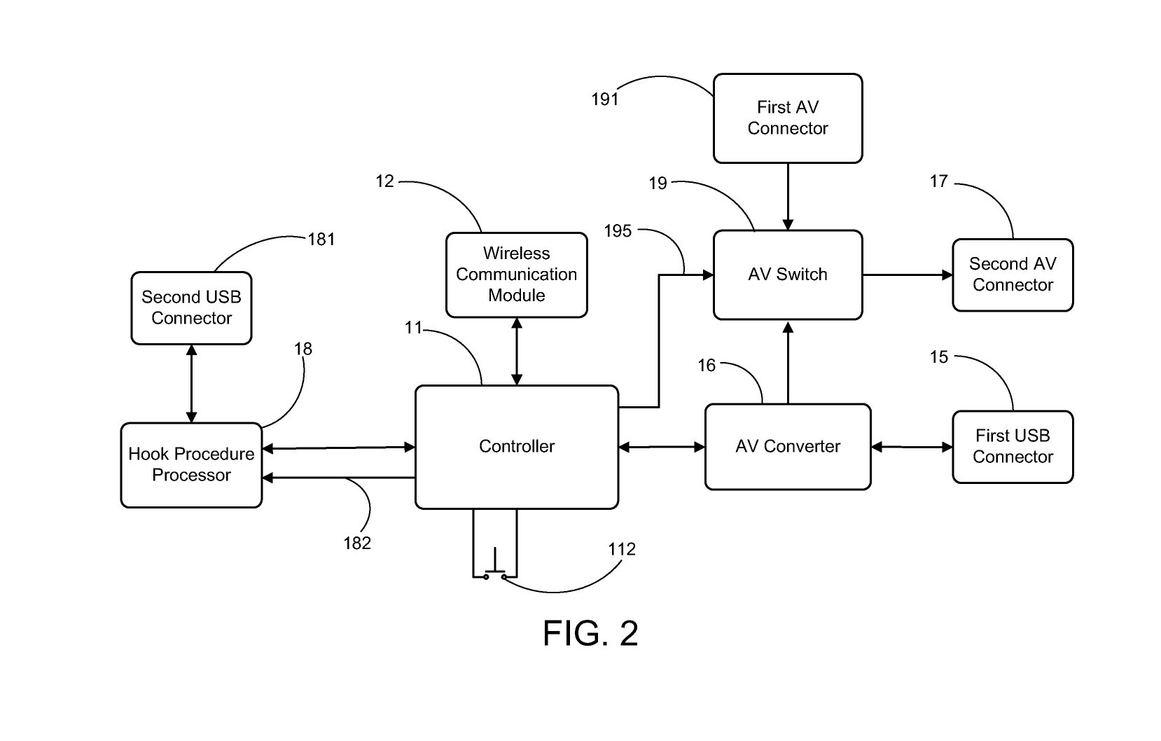

FIG. 2 shows a block diagram of the docking station 1 of the invention. As shown, the docking station 1 includes a controller 11 with a linking switch 112, a wireless communication module 12, a hook procedure processor 18, a first universal serial bus (USB) connector 15, a second USB connector 181, an audio/video (AV) converter 16, an AV switch 19, a first AV connector 191 and a second AV connector 17.

The controller 11 may be an ARM SoC (System-on-Chip) processor. The linking switch 112 connected to the controller 11 may be a normally-open push-button switch. The wireless communication module 12 is coupled to the controller 11 and capable of establishing a wireless link with the smartphone 2. Preferably, the wireless communication module 12 is provided with a BLUETOOTH interface. Accordingly, the wireless link is compliant with the BLUETOOTH standard.

As shown in FIG. 2, the AV converter 16 is coupled between the controller 11 and the first USB connector 15. The smartphone 2 outputs first AV data through the first USB connector 15 to the AV converter 16. The AV converter 16 converts first AV data into second AV data. The first AV data comes from the mobile AV interface abovementioned and from the smartphone 2. Preferably, the second AV data is compliant with the High-Definition Multimedia Interface (HDMI) standard.

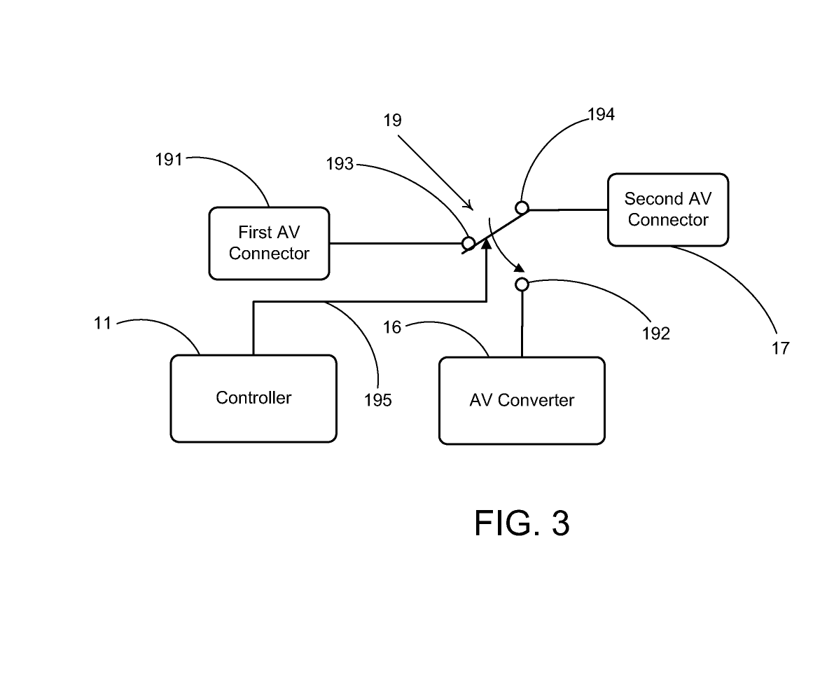

Please refer to FIG. 3. The AV switch 19 has a control terminal 195, an AV output 194 and two Av inputs 192, 193. The first and second AV connectors 191, 17 are of an HDMI type. The second AV connector 17 is coupled to the AV output 194 and the AV converter 16 is coupled to one of the two AV inputs 192, 193. The other AV input 193 is coupled to the first AV connector 17. As a result, either of the AV converter 16 and the first AV connector 17 can be selectively connected to the second AV connector 17. The control terminal 195 is coupled to the controller 11. As a result, the second AV connector 17 can be connected to either of the AV converter 16 and the first AV connector 191 by an operation of the linking switch 112 through the control terminal 195.

When the AV converter 16 is connected to the second AV connector 17, the second AV data is being output through the second AV connector 17 to the display 4 with a cable corresponding to the second AV connector 17. When the first AV connector 17 is connected to the second AV connector 17, a third AV data from the external laptop computer 6 to which the first AV connector 191 is connected is being output through the second AV connector 17 to the display 4.

The hook procedure processor 18 is coupled to the controller 11 and a second USB connector 181 is coupled to the hook procedure processor 18. A hook is a mechanism by which an application can intercept events, such as messages, mouse actions, and keystrokes. A function that intercepts a particular type of event is known as a hook procedure. A hook procedure can act on each event it receives, and then modify or discard the event. The term hooking covers a range of techniques used to alter or augment the behavior of an operating system, of applications, or of other software components by intercepting function calls or messages or events passed between software components. Code that handles such intercepted function calls, events or messages is called a “hook”. Hooking can include intercepting keyboard or mouse event messages before they reach an application, or intercepting operating system calls in order to monitor behavior or modify the function of an application or other component. As a result, the hook procedure processor 18 can intercept input device event messages of the keyboard 61 and touchpad 62 of the external laptop computer 6 connected to the second USB connector 181 to send them to the controller 11, and then the controller 11 sends input device event messages to the smartphone 2 through the wireless communication module 12. Finally, a user can use the keyboard 61 and touchpad 62 to input data to the smartphone 2.

Furthermore, the hook procedure processor 18 can be switched by the controller 11 through a control pin 182 to be in two modes, the first mode is outputting input device event messages to the controller 11, and the second mode is no outputting input device event messages. When the hook procedure processor 18 is switched to the first mode, the keyboard 61 and touchpad 62 of the laptop computer 6 can be used to input data to the smartphone 2. When the hook procedure processor 18 is switched to the second mode, the laptop computer 6 can work alone with its own keyboard 61 and touchpad 62. Preferably, the hook procedure processor 18 and the AV switch 19 are synchronously switched by operating the linking switch 182.

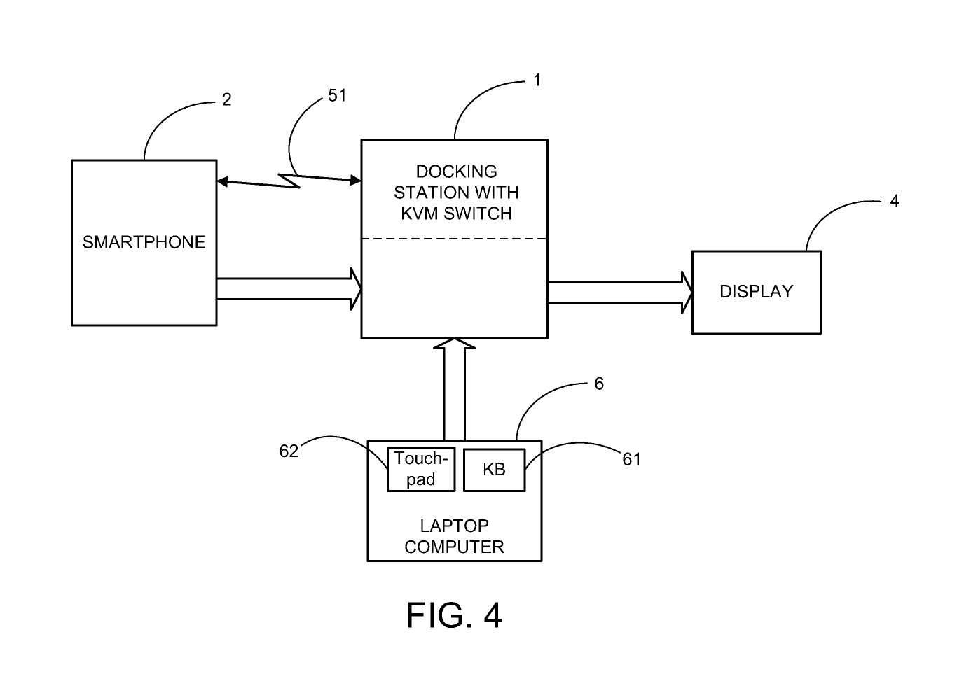

Please refer to FIG. 4. When the AV switch 19 connects the AV converter 16 to the second AV connector 17, the smartphone 2 can output AV data to the display 4 through the second AV connector 17. When the AV switch 19 connects the first AV connector 191 to the second AV connector 17, the display 4 will show AV data from the laptop computer 6. Meanwhile, a wireless link 51 is established between the smartphone 2 and the docking station 1. When the hook procedure processor 18 is switched to the first mode, a user can use the keyboard 61 and touchpad 62 to input data to the smartphone 2 through the wireless link.

It will be appreciated by persons skilled in the art that the above embodiments have been described by way of example only and not in any limitative sense, and that various alterations and modifications are possible without departure from the scope of the invention as defined by the appended claims.

What is claimed is:

1. A docking station comprising:
a controller, having a linking switch;
a wireless communication module, coupled to the controller, and being capable of establishing a wireless link with an external portable electronic device;
a first universal serial bus (USB) connector for connecting the external portable electronic device;
a hook procedure processor, coupled to the controller, and intercepting input device event messages of an external laptop computer to send to the controller;
a second USB connector, coupled to the hook procedure processor for connecting the external laptop computer;
an audio/video (AV) converter, coupled between the first USB connector and the controller for converting first AV data into second AV data;
an AV switch, having two AV inputs and an AV output for switching one of the two AV inputs to the AV output, and one of the two AV inputs being coupled to the AV converter;
a first AV connector, coupled to another one of the two AV inputs of the AV switch for inputting a third AV data from the external laptop computer; and
a second AV connector, coupled to the AV output of the AV switch for outputting either of the second AV data and the third AV data;
wherein the controller sends the input device event messages intercepted by the hook procedure processor to the external portable electronic device through the wireless link so that input devices of the external laptop computer can be used to input data into the external portable electronic device, the AV switch is controlled by the linking switch.

2. The docking station of claim 1, wherein the linking switch is a push-button switch.

3. The docking station of claim 1, wherein the wireless link is a BLUETOOTH link.

4. The docking station of claim 1, wherein the first AV data is compliant with either of a Mobile High-Definition Link (MHL) standard or a Mobility DisplayPort (MyDP) standard.

5. The docking station of claim 1, wherein the second AV connector and the second AV data are compliant with a High-Definition Multimedia Interface (HDMI) standard.

6. The docking station of claim 1, wherein the hook procedure processor is switched by the controller.

7. The docking station of claim 6, wherein the hook procedure processor and the AV switch are synchronously switched by the controller.
